(19) United States
(12) Patent Application Publication
(10) Pub. No.: US 2020/0151529 A1
(43) Pub. Date: May 14, 2020

(54) A METHOD FOR STORING DATA INDENTIFYING FABRIC INFORMATION DATA CARRIER

(71) Applicant: QINGDAO HAIER WASHING MACHINE CO., LTD., Shandong (CN)

(72) Inventors: Sheng XU, Shandong (CN); Hai SHU, Shandong (CN); Yang LI, Shandong (CN); Junming YIN, Shandong (CN); Zhenxing HUANG, Shandong (CN); Tao ZHANG, Shandong (CN)

(73) Assignee: QINGDAO HAIER WASHING MACHINE CO., LTD., Shandong (CN)

(21) Appl. No.: 16/618,557

(22) PCT Filed: Jun. 1, 2018
(86) PCT No.: PCT/CN2018/089442

§ 371 Date: Jan. 14, 2020

(30) Foreign Application Priority Data
Jun. 1, 2017 (CN) 201710406005.8

(51) Int. Cl. G06K 19/07

(52) U.S. Cl. CPC G06K 19/0723

(57) ABSTRACT

A method for storing data for identifying fabric information, comprises: dividing the fabric information into N types of data information according to information types, and storing the N types of data information on a data carrier in a form of codes respectively, wherein different codes in a same type of data information represent different pieces of the fabric information defined specifically. The fabric information is classified according to information types, and each type of data information represents specific defined information in the form of codes, thereby saving the storage space occupied by the fabric information. Also disclosed is a data carrier which can store a large amount of fabric information with a small space, the data carrier can acquire codes stored in the data carrier through identification by a corresponding identifier, and the identifier can further acquire specific fabric information according to the codes.

### TECHNICAL FIELD

The present disclosure relates to the field of household appliances or fabrics, in particular to a method for storing data for identifying fabric information and a data carrier.

### BACKGROUND

In the prior art, it is disclosed that a washing machine selects a corresponding matching program by identifying material information of fabrics.

For example, the present disclosure patent with the application number 201110401182.X discloses a washing machine and method capable of automatically identifying fabric material information to select a washing program. The washing machine includes a control system, a washing drum, a housing, a water inlet and outlet structure and a driving device, wherein the control system includes a computer program controller; the control system further includes an image processing device, an information input device and an information display device which are connected with the computer program controller; the image processing device includes an image acquisition unit, an image storage unit and an image identification unit which can identify a fabric according to a fabric image; and the control system establishes an ID number of the fabric according to the image acquired by the image acquisition unit and fabric information input by the information input device and stores the ID number in the image storage unit. In the present disclosure, a user is required to confirm the fabric information, but in actual application, a user probably does not know the fabric information and cannot provide accurate confirmation; besides, the identification accuracy of an identification system is not high enough, and a huge data set needs to be established to identify the information of each fabric, so the cost is high and the realization method is complicated.

Besides, in the prior art, an electronic tag may be arranged on a fabric, and fabric information is stored in the electronic tag, but the fabric information is not stored in the form of codes, thus requiring a large storage space to store little fabric information.

In addition, in the prior art, the tag on the fabric stores washing parameter information of the fabric, so the electronic tag can only be used for indicating the washing information of the fabric, thereby reducing the use range of the electronic tag and failing to allow the electronic tag to play a greater role.

In view of this, the present disclosure is proposed.

### SUMMARY

The technical problem to be solved by the present disclosure is to overcome the defects of the prior art and provide a method for storing data for identifying fabric information, which classifies the fabric information according to information types, and each type of data information represents defined specific information in the form of codes, thereby saving the storage space occupied by the fabric information. Further, the present disclosure also discloses a data carrier for data storage using the data storage method, wherein the data carrier can store a large amount of fabric information with a small space, the data carrier can acquire codes stored in the data carrier through identification by a corresponding identifier, and the identifier can further acquire specific fabric information according to the codes.

In order to solve the above technical problems, the basic idea of the technical solution adopted by the present disclosure is as follows.

A method for storing data for identifying fabric information, comprising: dividing the fabric information into N types of data information according to information types, and

storing the N types of data information on a data carrier in a form of codes respectively, and

different codes in a same type of data information represent different pieces of the fabric information defined specifically.

In the above solution, the fabric information is divided into N types and stored on the data carrier in the form of codes respectively, which is conducive to standardizing the storage mode of the fabric information, thus any fabric can be stored and defined. The method is simple and practical, and is worth popularizing. On the other hand, storing the data information in the form of codes saves the storage capacity of the fabric information. Compared with the existing storage mode, the solution stores more fabric information using a smaller storage space.

Preferably, appropriate bit numbers are allocated to each type of data information to store corresponding information according to the category quantity of each type of data information in the N types of data information.

In the above solution, the corresponding information is stored by allocating appropriate bit numbers to each type of data information according to the category quantity of each type of data information in the N type of data information. The design is reasonable and further saves the storage space. For example, clothes have material information and manufacturer information, and the existing material category quantity of clothes is far less than the number of manufacturers, so during storage space allocation, it is reasonable to allocate a larger storage space for manufacturer information than material information. Of course, the storage space allocated to each type of data information may be larger than the total category quantity of the existing type of data information, and there is still room for storage, so as to be compatible with the development of information in the field in the future. For example, if the existing material category quantity is M, the code which can be stored in the storage space allocated to material data has more than M variations, so that all the existing fabric material information can be completely represented in the storage space, and there may be more new fabric materials in the future, so the storage space can have a surplus.

On the other hand, the solution is not limited to the fact that the storage space allocated to each type of data information must be larger than the existing category quantity of the type of data information, and each type of data may be further divided into a plurality of sub-categories according to certain rules, so that the storage capacity of the storage space allocated to each type of data information only needs to be sufficient to distinguish the plurality of sub-categories. For example, the fabric material information includes jute, ramie, wool, rabbit hair, silk, spider silk, polyester, nylon, acrylic, etc., thus the materials can be classified as bast fiber material (jute, ramie), wool material (wool, rabbit hair), silk material (silk, spider silk), chemical fiber material (polyester, nylon, acrylic), and then the fabric material information can be allocated with two bits, for example, 00 represents bast fiber material, 01 represents wool material, 10 represents silk material, and 11 represents chemical fiber material (this example is for explanation only and is not used to limit the technical solution of the present disclosure).

Preferably, the N types of data information include fabric material information, fabric color information, and fabric category information, wherein bit numbers occupied by the fabric category information>bit numbers occupied by the fabric color information>bit numbers occupied by the fabric material information.

In the above solution, the fabric material information, the fabric color information and the fabric category information that are designed to be included in the N types of data information are the most important three types of data information of fabrics summarized by the inventors through a large number of experiments, and can basically meet the conventional requirements. These three types of data are very important data categories for fabrics. The fabric material information is an important basis for consumers to select fabrics, and is also an important reference basis for selecting detergents to wash fabrics, for example, the fabric material information can be used for realizing smart matching of washing procedures, can also meet the needs of people to select fabrics, and is also a basis for fabric recycling and classification. The color of fabrics is an important basis for consumers to choose fabrics, and is also an important reference basis to decide whether different fabrics can be washed together; in modern automation industry, this data information is important parameter information. The category information is not only an important basis for detergent selection, but also an important basis for washing strength, is also a basis for people to select fabrics, and is also important parameter information in future or present automatic design. Therefore, the fabric material information, the fabric color information and the fabric category information are three important types of data in the N types of data information of fabrics, are basically the most commonly needed information for industrial automation, and also meet the requirement of people for learning about fabric information. These three types of data information together can even be said to be an objective indicator of fabric performance.

Preferably, the fabric material information occupies 3-6 bits, the fabric color information occupies 4-6 bits, and the fabric category information occupies 5-7 bits. More preferably, the fabric material information occupies 4 bits, the fabric color information occupies 5 bits, and the fabric category information occupies 6 bits.

In the above solution, the design that the fabric material information occupies 4 bits, the fabric color information occupies 5 bits, and the fabric category information occupies 6 bits is the optimal storage mode summarized by the inventors through a great deal of research. By designing the specific storage bit numbers, the category information of fabrics can be basically distinguished, and the requirements of conventional classification can be met. For example, the fabric material information can be stored or indicated by 4 bits to distinguish 16 materials, which are cotton, bast fiber, mulberry silk, Tencel, real silk, silk, wool, cashmere, polypropylene, acrylic, spandex, viscose, nylon, polyester, chemical fiber and polyester fiber. These classifications fully meet the needs of people for detailed classification of fabric materials, can be used as a basis for washing machines to select matching fabric washing procedures and detergents, and can also be used as a basis for people to properly predict fabrics.

The present disclosure also provides a data carrier for storing data by the data storage method, comprising:

a first storage area, configured to store characteristic information of a fabric; and

the first storage area at least includes fabric material information storage module for storing fabric material information.

In the above solution, the fabric material information is the most important information of fabrics, and is related to various automatic control fields of related fabrics, such as the field of fabric classification and recycling, the field of fabric washing procedures matching, the field of fabric function analysis, the field of smart pricing of fabrics, etc.

Preferably, the first storage area further includes fabric color information storage module and fabric category information storage module;

the fabric color information storage module is configured to store corresponding fabric color information, and the fabric category information storage module is configured to store corresponding fabric category information;

preferably, the first storage area further includes a manufacturer information storage module and a fabric specification information storage module, wherein the manufacturer information storage module is configured to store fabric manufacturer information, and the fabric specification information storage module is configured to store fabric specification information.

In the above solution, specification data is a basis for fabric sorting, can be used as an important basis for smart sorting of fabrics and is also an important basis for fabric recycling. The manufacturer information can be used in the fields of fabric counterfeiting prevention and fabric evaluation.

Preferably, the fabric material information, the fabric color information, the fabric category information, the fabric specification information and the fabric manufacturer information are all codes, and different codes represent different pieces of the fabric information defined specifically.

In the above solution, the representation of the fabric material information, the fabric color information, the fabric category information, the fabric specification information, and the fabric manufacturer information in the form of codes is beneficial to saving the storage space. The data carrier of the present disclosure is fixed on a corresponding fabric for identifying fabric information in one kind of application, which will be used a lot, so the cost needs to be reduced as much as possible, and the cost can be directly reduced by reducing the storage space of the data carrier, thus the solution is the most practical low-cost solution.

Preferably, a capacity of the first storage area is M bytes, wherein a storage capacity of the manufacturer information storage module>a storage capacity of the fabric category information storage module>a storage capacity of the fabric color information storage module≥a storage capacity of the fabric specification information storage module>a storage capacity of the fabric material information storage module.

In the above solution, the storage capacities allocated to the storage modules are different because the category quantities of various types of information of fabrics are different, meanwhile, allocating different storage capacities to the storage modules is also a way to save the storage space of the data carrier, so when the storage area of the data carrier is configured in the way that the storage capacity of the manufacturer information storage module>the storage capacity of the fabric category information storage module>the storage capacity of the fabric color information storage module≥the storage capacity of the fabric specification information storage module>the storage capacity of the fabric material information storage module, more fabric information can be favorably stored.

Preferably, M is 4, the fabric manufacturer information occupies 12 bits, the fabric specification information occupies 5 bits, the fabric category information occupies 6 bits, the fabric color information occupies 5 bits, and the fabric material information occupies 4 bits.

Preferably, the data carrier further includes a second storage area, and the second storage area is configured to store manufacturer internal information of fabric manufacturers.

In the above solution, the data carrier is provided with the second storage area, which facilitates fabric identification by manufacturers, and the second storage area also increases the dependence of manufacturers on the data carrier, thus being beneficial to the popularization and application of the data carrier at manufacturers. The design is more reasonable, combines the needs of manufacturers with the needs of the outside, and is conducive to the promotion of the data carrier.

After the technical solution is adopted, compared with the prior art, the present disclosure has the following beneficial effects.

In the present disclosure, the fabric information is classified according to information types, and each type of data information represents defined specific information in the form of codes, thereby saving the storage space occupied by the fabric information. The present disclosure also provides a data carrier for data storage using the data storage method, wherein the data carrier can store a large amount of fabric information with a small space, the data carrier can acquire codes stored in the data carrier through identification by a corresponding identifier, and the identifier can further acquire specific fabric information according to the codes.

Specific embodiments of the present disclosure will be described in further detail in conjunction with the accompanying drawings below.

### BRIEF DESCRIPTION OF THE DRAWINGS

As a part of the present disclosure, the accompanying drawings are used to provide a further understanding of the present disclosure. The illustrative embodiments of the present disclosure and the description thereof are used to explain the present disclosure, but do not constitute an improper limitation of the present disclosure. Obviously, the drawings in the following description are only some embodiments. For those skilled in the art, other drawings can be obtained according to these drawings without creative labor. In the drawings:

FIG. 1 is a schematic diagram of a storage structure of a data carrier according to the present disclosure;

FIG. 2 shows storage steps of a method for storing a fabric information code in an electronic tag according to the present disclosure; and

FIG. 3 is a storage structure of the fabric information code in the electronic tag according to the present disclosure.

In the drawings: 1, fabric material information storage module; 2, fabric color information storage module; 3, fabric category information storage module; 4, fabric specification information storage module; 5, manufacturer information storage module.

It should be noted that the drawings and the written description are not intended to limit the scope of the inventive concept in any way, but to explain the inventive concept to those skilled in the art by referring to specific embodiments.

### DETAILED DESCRIPTION

In order to make the purpose, technical solution and advantages of the embodiments of the present disclosure clearer, the technical solution in the embodiments will be clearly and completely described below in conjunction with the drawings in the embodiments of the present disclosure. The following embodiments are used to illustrate the present disclosure, but are not used to limit the scope of the present disclosure.

In the description of the present disclosure, it should be noted that the orientation or position relationship indicated by the terms “upper”, “lower”, “inner” and “outer” are based on the orientation or position relationship shown in the drawings, only for convenience of describing the present disclosure and simplifying the description, and do not indicate or imply that the indicated device or element must have a specific orientation, or be constructed and operate in a specific orientation, and therefore cannot be understood as a limitation of the present disclosure.

In the description of the present disclosure, it should be noted that the terms “install” and “connect” should be understood in a broad sense unless otherwise specified and defined. For example, it can be fixed connection, detachable connection or integrated connection; it can be mechanical connection or electrical connection; and it can be direct connection or indirect connection through intermediate media. For those of ordinary skill in the art, the specific meaning of the above terms in the present disclosure can be understood in specific situations.

### Embodiment 1

The present embodiment provides a method for storing data for identifying fabric information, which includes: dividing the fabric information into N types of data information according to information types, and storing the N types of data information on a data carrier in a form of codes respectively, wherein different codes in a same type of data information represent different pieces of the fabric information defined specifically.

In the above solution, the fabric information is divided into N types and stored on the data carrier in the form of codes respectively, which is conducive to standardizing the storage mode of the fabric information, thus any fabric can be stored and defined. The method is simple and practical, and is worth popularizing. On the other hand, storing the data information in the form of codes saves the storage capacity of the fabric information. Compared with the existing storage mode, the solution stores more fabric information using a smaller storage space.

Preferably, according to the category quantity of each type of data information in the N type of data information, appropriate bit numbers are allocated to each type of data information to store corresponding information.

In the above solution, the corresponding information is stored by allocating appropriate bit numbers to each type of data information according to the category quantity of each type of data information in the N type of data information. The design is reasonable and further saves the storage space. For example, clothes have material information and manufacturer information, and the existing material category quantity of clothes is far less than the number of manufacturers, so during storage space allocation, it is reasonable to allocate a larger storage space for manufacturer information than material information. Of course, the storage space allocated to each type of data information can be larger than the total category quantity of the existing type of data information, and there is still room for storage, so as to be compatible with the development of information in the field in the future. For example, if the existing material category quantity is M, the code which can be stored in the storage space allocated to material data has more than M variations, so that all the existing fabric material information can be completely represented in the storage space, and there may be more new fabric materials in the future, so the storage space can have a surplus.

On the other hand, the solution is not limited to the fact that the storage space allocated to each type of data information must be larger than the existing category quantity of the type of data information, and each type of data may be further divided into a plurality of sub-categories according to certain rules, so that the storage capacity of the storage space allocated to each type of data information only needs to be sufficient to distinguish the plurality of sub-categories. For example, the fabric material information includes jute, ramie, wool, rabbit hair, silk, spider silk, polyester, nylon, acrylic, etc., thus the materials can be classified as bast fiber material (jute, ramie), wool material (wool, rabbit hair), silk material (silk, spider silk), chemical fiber material (polyester, nylon, acrylic), and then the fabric material information can be allocated with two bits, for example, 00 represents bast fiber material, 01 represents wool material, 10 represents silk material, and 11 represents chemical fiber material (this example is for explanation only and is not used to limit the technical solution of the present disclosure).

Preferably, the N types of data information include fabric material information, fabric color information, and fabric category information, wherein bit numbers occupied by the fabric category information>bit numbers occupied by the fabric color information>bit numbers occupied by the fabric material information.

In the above solution, the fabric material information, the fabric color information and the fabric category information that are designed to be included in the N types of data information are the most important three types of data information of fabrics summarized by the inventors through a large number of experiments, and can basically meet the conventional requirements. These three types of data are very important data categories for fabrics. The fabric material information is an important basis for consumers to select fabrics, and is also an important reference basis for selecting detergents to wash fabrics, for example, the fabric material information can be used for realizing smart matching of washing procedures, can also meet the needs of people to select fabrics, and is also a basis for fabric recycling and classification. The color of fabrics is an important basis for consumers to choose fabrics, and is also an important reference basis to decide whether different fabrics can be washed together; in modern automation industry, this data information is important parameter information. The category information is not only an important basis for detergent selection, but also an important basis for washing strength, is also a basis for people to select fabrics, and is also important parameter information in future or present automatic design. Therefore, the fabric material information, the fabric color information and the fabric category information are three important types of data in the N types of data information of fabrics, are basically the most commonly needed information for industrial automation, and also meet the requirement of people for learning about fabric information. These three types of data information together can even be said to be an objective indicator of fabric performance.

Preferably, the fabric material information occupies 3-6 bits, the fabric color information occupies 4-6 bits, and the fabric category information occupies 5-7 bits. More preferably, the fabric material information occupies 4 bits, the fabric color information occupies 5 bits, and the fabric category information occupies 6 bits.

In the above solution, the design that the fabric material information occupies 4 bits, the fabric color information occupies 5 bits, and the fabric category information occupies 6 bits is the optimal storage mode summarized by the inventors through a great deal of research. By designing the specific storage bit numbers, the category information of fabrics can be basically distinguished, and the requirements of conventional classification can be met. For example, the fabric material information can be stored or indicated by 4 bits to distinguish 16 materials, which are cotton, bast fiber, mulberry silk, Tencel, real silk, silk, wool, cashmere, polypropylene, acrylic, spandex, viscose, nylon, polyester, chemical fiber and polyester fiber. These classifications fully meet the needs of people for detailed classification of fabric materials, can be used as a basis for washing machines to select matching fabric washing procedures and detergents, and can also be used as a basis for people to properly predict fabrics.

### Embodiment 2

The present embodiment provides a data carrier for storing data by the data storage method in Embodiment 1, comprising:

a first storage area, configured to store characteristic information of a fabric;

wherein the first storage area at least includes fabric material information storage module configured to store fabric material information.

In the above solution, the fabric material information is the most important information of fabrics, and is related to various automatic control fields of related fabrics, such as the field of fabric classification and recycling, the field of fabric washing program matching, the field of fabric function analysis, the field of smart pricing of fabrics, etc.

Preferably, the first storage area further includes fabric color information storage module and fabric category information storage module;

the fabric color information storage module is configured to store corresponding fabric color information, and the fabric category information storage module is configured to store corresponding fabric category information;

preferably, the first storage area further includes a manufacturer information storage module and a fabric specification information storage module, wherein the manufacturer information storage module is configured to store fabric manufacturer information, and the fabric specification information storage module is configured to store fabric specification information.

In the above solution, specification data is a basis for fabric sorting, can be used as an important basis for smart sorting of fabrics and is also an important basis for fabric recycling. The manufacturer information can be used in the fields of fabric counterfeiting prevention and fabric evaluation.

Preferably, the fabric material information, the fabric color information, the fabric category information, the fabric specification information and the fabric manufacturer information are all codes, and different codes represent different pieces of the fabric information defined specifically.

In the above solution, the representation of the fabric material information, the fabric color information, the fabric category information, the fabric specification information, and the fabric manufacturer information in the form of codes is beneficial to saving the storage space. The data carrier of the present disclosure is fixed on a corresponding fabric for identifying fabric information in one kind of application, and is a data carrier which will be used a lot, so the cost needs to be reduced as much as possible, and the cost can be directly reduced by reducing the storage space of the data carrier, thus the solution is the most practical low-cost solution.

Preferably, the capacity of the first storage area is M bytes, wherein the storage capacity of the manufacturer information storage module>the storage capacity of the fabric category information storage module>the storage capacity of the fabric color information storage module≥the storage capacity of the fabric specification information storage module>the storage capacity of the fabric material information storage module.

In the above solution, the storage capacities allocated to the storage modules are different because the category quantities of various types of information of fabrics are different, meanwhile, allocating different storage capacities to the storage modules is also a way to save the storage space of the data carrier, so when the storage area of the data carrier is configured in the way that the storage capacity of the manufacturer information storage module>the storage capacity of the fabric category information storage module>the storage capacity of the fabric color information storage module≥the storage capacity of the fabric specification information storage module>the storage capacity of the fabric material information storage module, more fabric information can be favorably stored.

Preferably, M is 4, the fabric manufacturer information occupies 12 bits, the fabric specification information occupies 5 bits, the fabric category information occupies 6 bits, the fabric color information occupies 5 bits, and the fabric material information occupies 4 bits.

Preferably, the data carrier further includes a second storage area, and the second storage area is configured to store manufacturer internal information of fabric manufacturers.

In the above solution, the data carrier is provided with the second storage area, which facilitates fabric identification by manufacturers, and the second storage area also increases the dependence of manufacturers on the data carrier, thus being beneficial to the popularization and application of the data carrier at manufacturers. The design is more reasonable, combines the needs of manufacturers with the needs of the outside, and is conducive to the promotion of the data carrier.

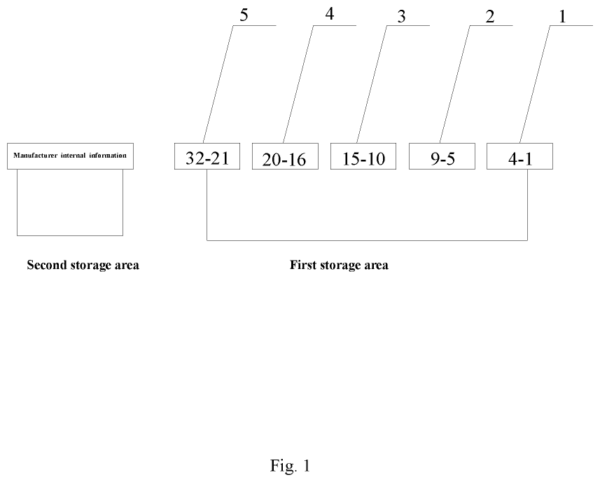

Specifically, as shown in FIG. 1, the data carrier includes the first storage area and the second storage area. The first storage area includes 32 bits, high to low from right to left, wherein the first storage area includes five storage modules, which are, from high to low, the fabric material information storage module 1, the fabric color information storage module 2, the fabric category information storage module 3, the fabric specification information storage module 4, and the manufacturer information storage module 5 respectively. The fabric material information storage module 1 occupies 4 bits, the fabric color information storage module 2 occupies 5 bits, the fabric category information storage module 3 occupies 6 bits, the fabric specification information storage module 4 occupies 5 bits, and the manufacturer information storage module 5 occupies 12 bits.

### Embodiment 3

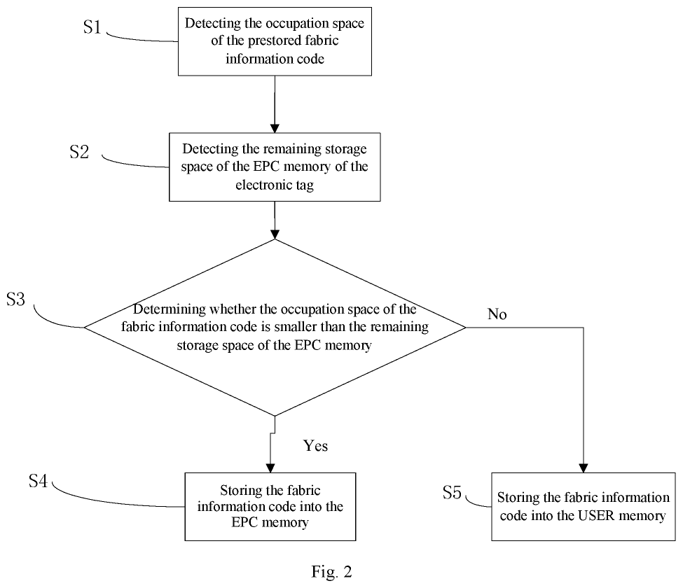

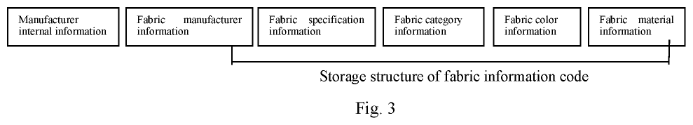

Embodiment 3 further provides a method for storing fabric information on the data carrier based on Embodiment 2, wherein the data carrier is an electronic tag, as shown in FIGS. 2 to 3, and the electronic tag at least includes an EPC memory for storing an electronic product code for identifying a tag object and a USER memory for storing user-defined data, and is configured to indicate a fabric information code. The storage method includes: detecting the remaining storage space of the EPC memory of the electronic tag; storing the fabric information code in the EPC memory when the storage space is enough to store the fabric information code; otherwise, storing the fabric information code in the USER memory. Meanwhile, different writing priorities are used for different types of fabric information in the storage process, thus ensuring that the electronic tag can completely and effectively store different types of key fabric information and meeting the requirement of smart washing of a washing machine.

As shown in FIGS. 2 to 3, the fabric information indicated by the fabric information code in the present embodiment includes fabric attribute information, namely the characteristic information of the fabric, and the fabric attributes in the present embodiment include fabric material information, fabric color information, fabric category information, fabric specification information, fabric manufacturer information and the like.

According to the RFID-based electronic tag storage technology of the present embodiment, the storage method and the electronic tag conform to the EPC Class1 Gen2 protocol. Under this protocol, an electronic tag memory is divided into four independent memories, which are respectively a RESERVED memory, an EPC memory, a tag identifier (TID) memory and a USER memory. The RESERVED memory is configured to manage the kill password and access password of the electronic tag. The TID memory generally stores the information provided by an electronic tag chip manufacturer, the EPC memory generally stores the electronic product code, i.e. the identification information, and the USER memory stores business data, which needs to be defined by a user according to the application.

In order to ensure the storage integrity of the fabric information code, the storage method of the present disclosure is shown in FIG. 2 and includes the following steps:

S1, detecting the occupation space of the code of prestored fabric information;

S2, detecting the remaining storage space of the EPC memory of the electronic tag;

S3, determining whether the occupation space of the code of fabric information is smaller than the remaining storage space of the EPC memory; proceeding to S4 when the occupation space of the fabric information code is smaller than the remaining storage space of the EPC memory; otherwise, proceeding to S5;

S4, storing the fabric information code into the EPC memory; and

S5, storing the fabric information code into the USER memory.

In the method, before the fabric information code is stored, the encoding length of the prestored fabric information code is scanned by a scanning unit, the storage space required by the fabric information code is calculated, and the storage position of the fabric information code is determined according to the remaining space information fed back through scanning of the memory space. Under normal circumstances, the fabric information code is preferentially stored in the EPC memory, but when the storage space required by the fabric information code is found to be larger than the remaining space of the EPC memory after the above-mentioned operation steps, the fabric information code is integrally stored in the USER area.

When being written into the corresponding storage areas, different types of fabric attribute information indicated by the fabric information code have different writing priorities in the process of writing into the memory. Taking the fabric attributes in the present embodiment as an example, the priority order of writing into the memory is: fabric material information>fabric color information>fabric category information>fabric specification information>fabric manufacturer information.

In order to realize this priority, as shown in FIG. 3, the storage areas of the fabric attributes corresponding to the electronic tag in this method are consistent with the encoding distribution of the fabric information code. The fabric material information which has the greatest influence on fabric washing is first stored into the electronic tag, then the fabric color information, and so on. In this way, it is ensured that in the case of failed writing and storage failure due to unexpected conditions or storage overflow, the key data with the highest priority which is first written in is well stored, thus ensuring the fabric washing effect to the greatest extent.

In the present disclosure, the encoding length of the fabric information code is 4-45 bits, and all the fabric attribute information is sequentially written into the memory from high to low; specifically, in the present embodiment, the encoding length of the fabric information code is 32 bits. The electronic tag is divided into different storage areas according to fabric information types, wherein the size of storage spaces occupied by different types of information in the different storage areas are not completely the same; in the present embodiment, the storage spaces occupied by all the fabric attribute information are divided according to the following relation: fabric manufacturer information>fabric category information>fabric color information≥fabric specification information>fabric material information.

In the present embodiment, the specific encoding space distribution under the storage structure rule in the electronic tag of FIG. 3 is as follows:

the fabric manufacturer information occupies 12 bits, the fabric specification information occupies 5 bits, the fabric category information occupies 6 bits, the fabric color information occupies 5 bits, and the fabric material information occupies 4 bits.

It should also be noted that as shown in FIG. 3, the fabric information code stored in the electronic tag usually also includes a fabric manufacturer internal code defined by a fabric manufacturer. Therefore, in addition to storing the fabric information code, the memory also needs to store the fabric manufacturer internal code, which has no substantial significance for clothes washing. As a result, in the process of storing the codes, the priority of the fabric manufacturer internal code is lower than the priority of the fabric information code.

The codes stored in the electronic tag in the embodiment include the fabric manufacturer internal code defined by the fabric manufacturer and the fabric information code defined by a washing machine manufacturer, and these codes cannot be modified after being written into the electronic tag.

It should be noted that in the present embodiment, the fabric attributes refer to the types of fabric information.

The above description is only preferred embodiments of the present disclosure, and is not intended to limit the present disclosure in any form. Although the present disclosure has been disclosed in the preferred embodiments, it is not intended to limit the present disclosure. Any person familiar with this patent can make some changes or modifications to equivalent embodiments with equivalent changes by using the above-mentioned technical contents without departing from the scope of the technical solution of the present disclosure. However, any simple amendments, equivalent changes and modifications made to the above embodiments according to the technical essence of the present disclosure without departing from the contents of the technical solution of the present disclosure are still within the scope of the solution of the present disclosure.

1. A method for storing data for identifying fabric information, comprising: dividing the fabric information into N types of data information according to information types, and
storing the N types of data information on a data carrier in a form of codes respectively, and
different codes in a same type of data information represent different pieces of the fabric information defined specifically.

2. The method for storing data for identifying fabric information according to claim 1, wherein bit numbers are allocated to each type of data information to store corresponding information according to the quantity of each type of data information in the N types of data information.

3. The method for storing data for identifying fabric information according to claim 2, wherein the N types of data information include fabric material information, fabric color information and fabric category information, and
bit numbers occupied by the fabric category information>bit numbers occupied by the fabric color information>bit numbers occupied by the fabric material information.

4. The method for storing data for identifying fabric information according to claim 1, wherein the fabric material information occupies 4 bits, the fabric color information occupies 5 bits, and the fabric category information occupies 6 bits.

5. A data carrier for storing data by the data storage method according to claim 1, comprising:
a first storage area, configured to store characteristic information of a fabric; and
the first storage area at least comprises fabric material information storage module for storing fabric material information.

6. The data carrier according to claim 5, wherein the first storage area further comprises fabric color information storage module and fabric category information storage module;
the fabric color information storage module is configured to store fabric color information, and
the fabric category information storage module is configured to store fabric category information.

7. The data carrier according to claim 11, wherein the fabric material information, the fabric color information, the fabric category information, the fabric specification information and the fabric manufacturer information are all codes, and different codes represent different pieces of the fabric information defined specifically.

8. The data carrier according to claim 11, wherein a capacity of the first storage area is M bytes, and
a storage capacity of the manufacturer information storage module>a storage capacity of the fabric category information storage module>a storage capacity of the fabric color information storage module≥a storage capacity of the fabric specification information storage module>a storage capacity of the fabric material information storage module.

9. The data carrier according to claim 8, wherein M is 4, and
the fabric manufacturer information occupies 12 bits, the fabric specification information occupies 5 bits, the fabric category information occupies 6 bits, the fabric color information occupies 5 bits, and the fabric material information occupies 4 bits.

10. The data carrier according to claim 1, further comprising a second storage area, and
the second storage area is configured to store manufacturer internal information of fabric manufacturers.

11. The data carrier according to claim 6, wherein the first storage area further comprises a manufacturer information storage module and a fabric specification information storage module, and the manufacturer information storage module is configured to store fabric manufacturer information, and the fabric specification information storage module is configured to store fabric specification information.
